(19) United States
(12) Patent Application Publication
(10) Pub. No.: US 2009/0043850 A1
(43) Pub. Date: Feb. 12, 2009

(54) SYSTEM AND METHOD FOR COLLABORATION

(75) Inventors: Robert Cameron Weir, Westford, MA (US); Barry E. Willner, Briarcliff Manor, NY (US); Patrick Joseph O'Sullivan, Ballsbridge (IE); Edith Helen Stern, Yorktown Heights, NY (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/834,261

(22) Filed: Aug. 6, 2007

(51) Int. Cl. G06F 15/16

(52) U.S. Cl. 709/206

(57) ABSTRACT

A method and computer program product for generating an email message from a first user that solicits a response message. A determination is made concerning whether the response message to the email message is still permitted. If the response message to the email message is still permitted, a second user is allowed to generate the response message.

### TECHNICAL FIELD

This disclosure relates to collaboration and, more particularly, to automatic online collaboration in response to an initiating email message.

### BACKGROUND

Email systems, as currently implemented, offer insufficient coordination and collaboration. Specifically, a one-to-many email may provide the required information to a large number of people, but the current systems do not easily handle the subsequent responses, both back to the original sender as well as amongst various recipients. For example, if twenty people are sent an email and they all respond and copy each other, an email storm of over four-hundred messages is the result.

Conventional approaches to solving this problem have included the use of threaded email views, which allows the email user to organize the larger volume of information in a topical manner. However, this does not radically reduce the amount of time needed to read, correlate and summarize the email responses.

### SUMMARY OF DISCLOSURE

In a first implementation, a method includes generating an email message from a first user that solicits a response message. A determination is made concerning whether the response message to the email message is still permitted. If the response message to the email message is still permitted, a second user is allowed to generate the response message.

One or more of the following features may be included. The email message may be transmitted. The response message may be transmitted. At least a portion of the email message may be posted to an online collaborative workspace. At least a portion of the response message may be posted to the online collaborative workspace.

The online collaborative workspace may be chosen from the group consisting of: a wiki; a blog; a teamspace; a discussion group; and an activity group. The at least a portion of the email message and the at least a portion of the response message may be posted within the collaborative workspace in a chronological fashion.

If the response message to the email message is no longer permitted, the generation of the response message by the second user may be prohibited. The response message solicited may be a multi-part response message that may include a plurality of individual response messages.

Determining if the response message to the email message is still permitted may include determining if any of the plurality of individual response messages to the email message are still permitted. Allowing the generation of the response message by a second user may include: if any of the plurality of individual response messages to the email message are still permitted, allowing the generation of the response message by the second user. If none of the plurality of individual response messages to the email message are still permitted, the generation of the response message by the second user may be prohibited.

In another implementation, a computer program product resides on a computer readable medium that has a plurality of instructions stored on it. When executed by a processor, the instructions cause the processor to perform operations including generating an email message from a first user that solicits a response message. A determination is made concerning whether the response message to the email message is still permitted. If the response message to the email message is still permitted, a second user is allowed to generate the response message.

One or more of the following features may be included. The email message may be transmitted. The response message may be transmitted. At least a portion of the email message may be posted to an online collaborative workspace. At least a portion of the response message may be posted to the online collaborative workspace.

The online collaborative workspace may be chosen from the group consisting of: a wiki; a blog; a teamspace; a discussion group; and an activity group. The at least a portion of the email message and the at least a portion of the response message may be posted within the collaborative workspace in a chronological fashion.

If the response message to the email message is no longer permitted, the generation of the response message by the second user may be prohibited. The response message solicited may be a multi-part response message that may include a plurality of individual response messages.

Determining if the response message to the email message is still permitted may include determining if any of the plurality of individual response messages to the email message are still permitted. Allowing the generation of the response message by a second user may include: if any of the plurality of individual response messages to the email message are still permitted, allowing the generation of the response message by the second user. If none of the plurality of individual response messages to the email message are still permitted, the generation of the response message by the second user may be prohibited.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a collaboration process and an email client application coupled to a distributed computing network;

FIG. 2 is a flowchart of a process executed by the collaboration process of FIG. 1;

FIG. 3 is a diagrammatic view of a display screen rendered by the collaboration process and/or the email client application of FIG. 1; and

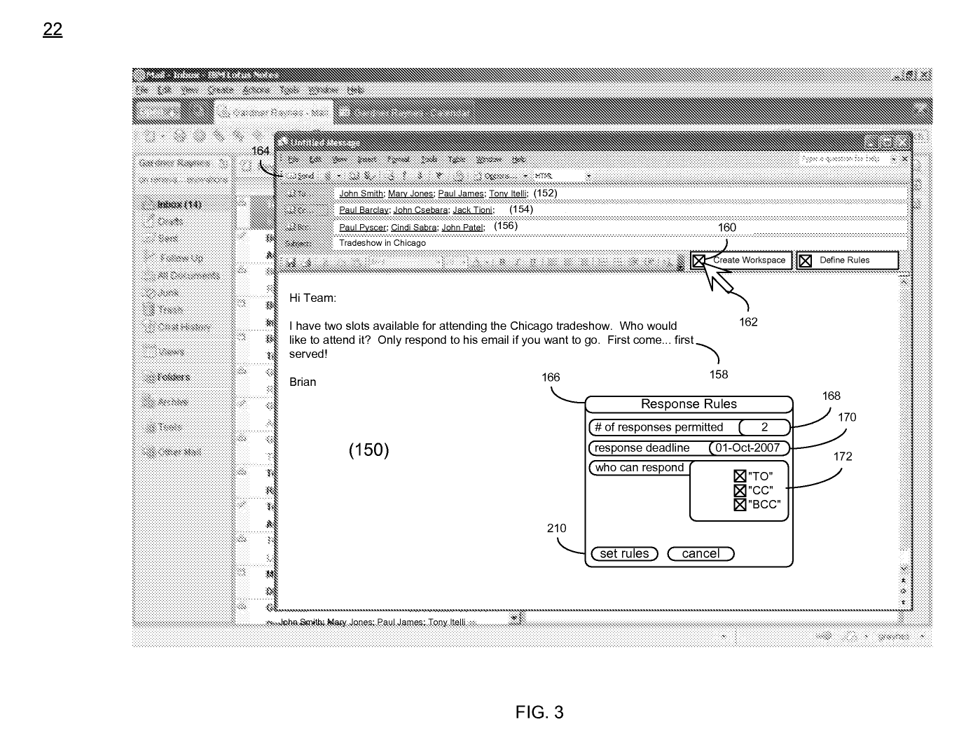

FIG. 4 is a diagrammatic view of a display screen rendered by the collaboration process and/or the email client application of FIG. 1.

Like reference symbols in the various drawings indicate like elements.

### DETAILED DESCRIPTION OF THE PREFERRED EMBODIMENTS

### System Overview:

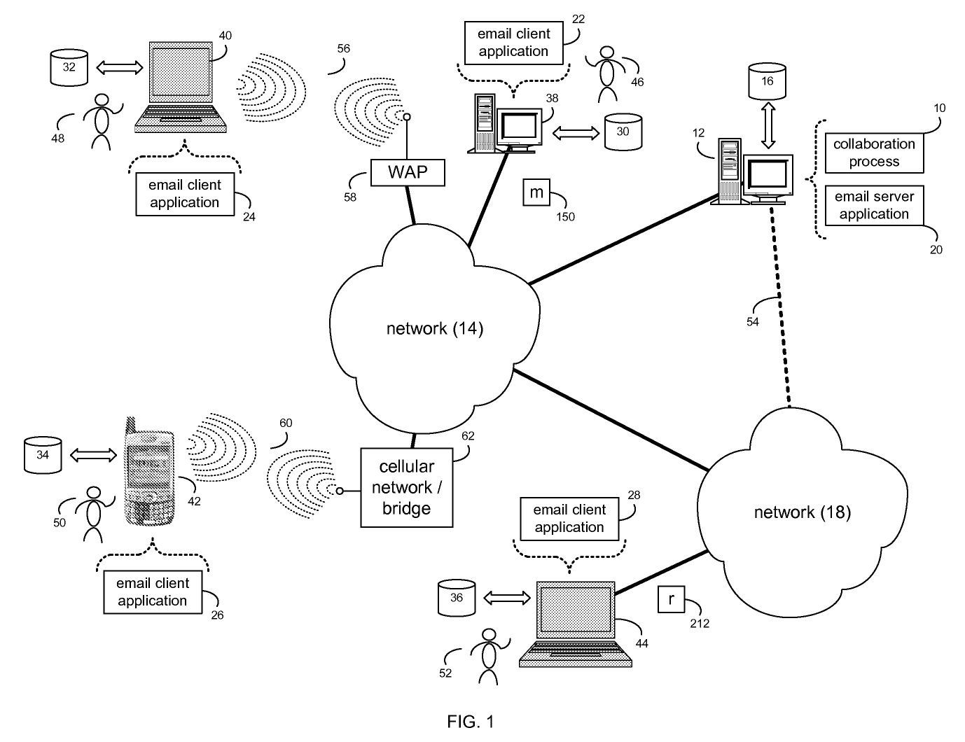

Referring to FIG. 1, there is shown collaboration process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. As will be discussed below in greater detail, collaboration process 10 may allow a first user to generate an email message that solicits a response. When a second user attempts to generate a response to the email message generated by the first user, collaboration process 10 may determine whether a response is still permitted. If so, the second user may be allowed to generate the response.

The instruction sets and subroutines of collaboration process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute email server application 20, examples of which may include but are not limited to Lotus Domino™ Server and Microsoft Exchange™ Server. Email server application 20 may be a mail transfer agent that may store and route email to one or more email client applications 22, 24, 26, 28, examples of which may include but are not limited to Lotus Notes™ and Microsoft Outlook™. Collaboration process 10 may be a stand alone application that interfaces with email server application 20 or an applet/application that is executed within email server application 20.

The instruction sets and subroutines of email server application 20, which may be stored on storage device 16 coupled to server computer 12 may be executed by one or more processors (not shown) and one or more memory architectures (not shown) incorporated into server computer 12.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using email client applications 22, 24, 26, 28, users 46, 48, 50, 52 may access email server application 20 and may retrieve and/or organize email messages.

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Collaboration Process:

For the following discussion, email client application 22 is going to be described for illustrative purposes. However, this is not intended to be a limitation of this disclosure, as other email client applications (e.g., email client applications 24, 26, 28) may be equally utilized.

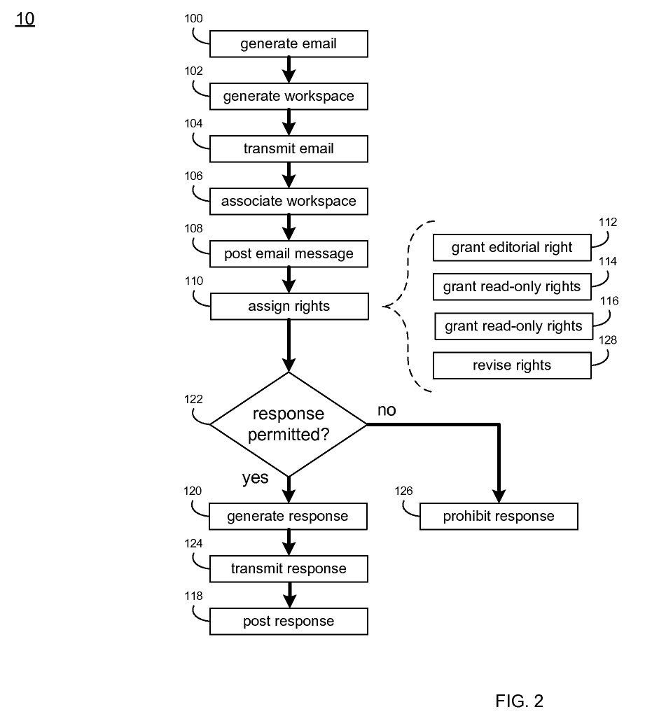

Referring also to FIGS. 2 & 3, email client application 22 (alone or in combination with collaboration process 10 and/or email server application 20) may allow a user (e.g., user 46) to generate 100 email message 150 that is addressed to one or more recipients. As is known in the art, email message 150 may be addressed to “TO” recipients 152, “CC” (i.e., carbon copy) recipients 154, and “BCC” (blind carbon copy) recipients 156. Further and as is known in the art, email message 150 may include message content 158 (i.e., the body of the email message) that may solicit a response from the recipients of email message 150. For example, message content 158 included within email message 150 may include a question, such as:
I have two slots available for attending the Chicago tradeshow. Who would like to attend it? Only respond to his email if you want to go. First come . . . first served!”.

Accordingly, email message 150 is soliciting a response from the recipients of the email. When generating 100 email message 150, user 46 (i.e., the user of email client application 22) may choose to generate 102 an online collaborative workspace 200. Examples of online collaborative workspace 200 may include but are not limited to: a wiki; a blog; a teamspace; a discussion group; and an activity group.

A wiki is a website that may allow visitors to add, remove, and edit content. A collaborative technology for organizing information on websites, wikis may allow for linking amongst any number of webpages. Wikis may be editable by the general public.

A blog is a website in which entries may be written in a chronological order and may be displayed in reverse chronological order. Blogs may provide commentary or news on a particular subject such as food, politics, or local news; or may function as a personal online diary.

A teamspace is a web-based collaborative workspace for managing shared work processes and maintaining shared artifacts in a project that may span months or years. A teamspace may cover both synchronous and asynchronous cross-company team activities and may provide a seamless transition between different work modes.

A discussion group is a web application for holding discussions and posting user-generated content. The term “group” may refer to the entire community or to a specific sub-forum dealing with a distinct topic. Messages within a sub-forum may be displayed either in chronological order or as threaded discussions.

An activity may be a collaborative event in which multiple users collaborate to achieve a common goal. For example, members of an activity may be allowed to contribute and share content amongst members to facilitate the completion of the goal.

Online collaborative workspace 200 may allow users to collaborate, exchange content, establish timelines, allocate resources, and establish schedules/goals required to achieve a common goal. For example, a common goal may concern the attendance of Company X at the above-referenced Chicago tradeshow. Specifically, this common goal may include a plurality of discrete tasks, such as securing booth space at the tradeshow so that Company X may exhibit their goods/services. Additionally, Company X may need to make travel arrangements, arrange for the shipping of booth backdrops, platforms and tables. Further, Company X may need to have signage created and may need to obtain trinkets for giving to visitors of their booth. Accordingly, Company X attending a tradeshow may be a common goal that may include a plurality of discrete tasks.

As would be expected, each of these discrete tasks may be performed by different individuals (or different groups of individuals). In order to increase efficiency, it may be desirable for each individual (or group of individuals) to collaborate with each other.

As discussed above, when generating 100 email message 150, user 46 may choose to generate 102 an online collaborative workspace 200. Accordingly, user 46 may e.g., select “Create Workspace” checkbox 160 (using onscreen pointer 162 that is controllable by a pointing device, not shown). User 46 may then select “Send” button 164 using onscreen pointer 162, which may result in email message 150 being transmitted 104 to the one or more recipients.

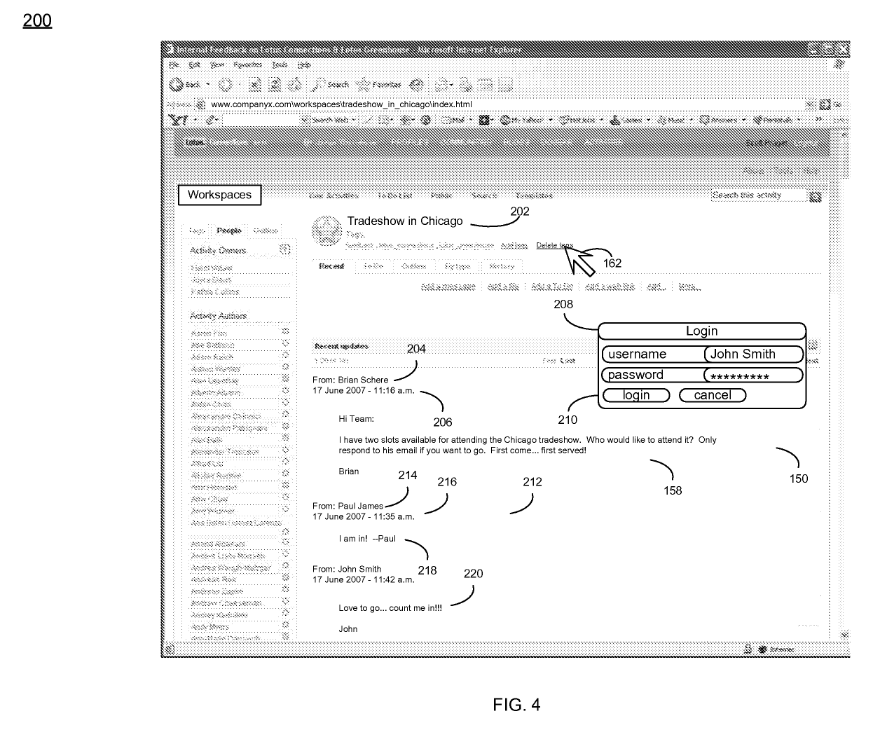

Referring also to FIG. 4, collaboration process 10 may generate 102 online collaborative workspace 200 and may associate 106 online collaborative workspace 200 with email message 150. For example, collaboration process 10 may set the title 202 of online collaborative workplace 200 to be the same as the subject of email message 150. For illustrative purposes, the title 202 of online collaborative workspace 200 is set to “Tradeshow in Chicago”. When generating 102 online collaborative workspace 200, collaboration process 10 may define one or more directories and may generate one or more webpages. For example, collaboration process 10 may define directory “tradeshow_in_chicago” as a subdirectory of directory “workspaces” in the domain “www.companyx.com”.

When generating 102 online collaborative workspace 200, collaboration process 10 may post 108 at least a portion of email message 150 to online collaborative workspace 200. For example and for illustrative purposes, online collaborative workspace 200 is shown to include message content 158 from email message 150. Additionally, collaboration process 10 is shown to include (within online collaborative workspace 200) a poster identifier 204 for identifying the poster of the entry (i.e., email message 150) within online collaborative workspace 200. Additionally, collaboration process 10 may include time/date stamp 206 that defines the time that the entry was posted to online collaborative workspace 200. Time/date stamp 206 may be a time/date stamp extracted from email message 150.

As discussed above, email message 150 may be addressed to: “TO” recipients 152 (e.g., John Smith, Mary Jones, Paul James & Tony Itelli); “CC” recipients 154 (e.g., Paul Barclay, John Csebara & Jack Tioni); and “BCC” recipients 156 (e.g., Paul Pyscer, Cindi Sabra & John Patel).

Collaboration process 10 may allow user 46 to assign 110 rights, concerning online collaborative workspace 200, to at least a portion of the recipients of email message 150. For example, user 46 (via collaboration process 10) may grant 112 editorial rights, concerning online collaborative workspace 200, to “TO” recipients 152. Additionally, user 46 (via collaboration process 10) may grant 114 read-only rights, concerning online collaborative workspace 200, to “CC” recipients 154. Further, user 46 (via collaboration process 10) may grant 116 read-only rights, concerning online collaborative workspace 200, to “BCC” recipients 156. These examples are for illustrative purposes only and are not intended to be a limitation of this disclosure. Specifically, the types of rights and the manner in which the rights are distributed may vary depending upon e.g., design criteria and system requirements.

If “TO” recipients 152 (e.g., John Smith, Mary Jones, Paul James & Tony Itelli) are granted 112 editorial rights, “TO” recipients 152 may be allowed to review and edit content included within online collaboration process 200. For example, “John Smith” may be allowed to modify (e.g., edit/remove) message content 158 included within online collaborative workspace 200. Additionally, “John Smith” may be allowed to add/post content to online collaborative workspace 200.

If “CC” recipients 154 (e.g., Paul Barclay, John Csebara & Jack Tioni) are granted 114 read-only rights, “CC” recipients 154 may be allowed to review content included within online collaboration process 200. For example, “Paul Barclay” may be allowed to review message content 158 included within online collaborative workspace 200.

If “BCC” recipients 156 (e.g., Paul Pyscer, Cindi Sabra & John Patel) are granted 116 read-only rights, “BCC” recipients 156 may be allowed to review content included within online collaboration process 200. For example, “Paul Pyscer” may be allowed to review message content 158 included within online collaborative workspace 200.

As different users of online collaborative workspace 200 may be assigned different rights, when a user attempts to access online collaborative workspace 200, the user may be required to log into online collaborative workspace 200. For example, upon user 46 attempting to access:

www.companyx.com\workspaces\tradeshow_in_chicago\index.html

user 46 may be required to e.g., enter a user name and password into login popup menu 208. Within menu 208, user 46 may enter a “username” and “password” that allows them to access online collaborative workspace 200. Once the requisite data in entered into the appropriate data fields within menu 208, user 46 may select “login” button 210 (using onscreen pointer 162).

Upon reviewing email message 150, one or more of the recipients (e.g., “TO” recipients 152, “CC” recipients 154, and “BCC” recipients 156) may wish to generate a response concerning email message 150, which collaboration process 10 may post 118 to online collaborative workspace 200.

As discussed above, collaboration process 10 may allow a first user (e.g., user 46) to generate 100 an email message (e.g., email message 150) that solicits a response. When a second user (e.g., user 48) attempts to generate 120 a response to email message 150 generated 100 by user 46, collaboration process 10 may determine 122 whether a response is still permitted. If 122 the response is still permitted, the second user may be allowed to generate 120 and transmit 124 the response. At least a portion of the response message may be posted 118 to online collaborative workspace 200. If 122 the response is not permitted, the second user may be prohibited 126 from generating the response.

Concerning whether the response to the email message is still permitted, collaboration process 10 may allow the user to define one or more response rules that are processed to determine 122 whether a response to an email message is permitted. For example, when generating 100 email message 150, user 46 may e.g., check (using onscreen pointer 162) the “Define Rules” checkbox, which may result in collaboration process 10 rendering “Response Rules” popup menu 166. “Response Rules” popup menu 166 may allow user 46 to define one or more rules concerning responding to the subject email message (e.g., email message 150). For example, user 46 may define the maximum number of responses that user 46 may accept concerning email message 150. For example, as user 46 specified that there are only “two slots” available for the Chicago tradeshow, user 46 may enter the number “2” within field 168, thus limiting the total number of responses accepted (with respect to email message 150) to the first two responses received. As a further example, user 46 may define a response deadline that allows a recipient to submit a response up until the deadline defined within deadline field 170. And additionally, user 46 may define who may respond to email message 150. For example, by selecting the “TO” box within respondent field 172, “TO” recipients (e.g., John Smith, Mary Jones, Paul James & Tony Itelli) may be allowed to respond to email message 150. By selecting the “CC” field within respondent field 172, “CC” recipients (e.g., Paul Barclay, John Csebara & Jack Tioni) may be allowed to respond to email message 150. Further, by selecting the “BCC” field within respondent field 172, “BCC” recipients (e.g., Paul Pyscer, Cindi Sabra & John Patel) may be allowed to respond to email message 150. Collaboration process 10 may allow user 46 to apply each of the above-described rules independently or in combination with other rules. Further, while “Response Rules” popup menu 166 is shown to include three rules, this is for illustrative purposes only and is not intended to be a limitation of this disclosure, as the number of rules may be increased/decreased in accordance with design criteria and need.

For example and as discussed above, Brian Schere (i.e., user 46) generated email message 150, which states:
I have two slots available for attending the Chicago tradeshow. Who would like to attend it? Only respond to his email if you want to go. First come . . . first served!

Accordingly, using “Response Rules” popup menu 166, user 46 may define rules that: a) limit the number of responses to “2” (see field 168); b) sets a response deadline to 1 Oct. 2007 (see field 170); and allows “TO” recipients 152, “CC” recipients 154, and “BCC” recipients 156 to reply to email message 150 (see field 172).

Continuing with the above-stated example, assume that “TO” recipient “Paul James” would like to attend the Chicago tradeshow and immediately begins preparing response 212 (in the form of a separate email message) concerning email message 150. Collaboration process 10 may determine 122 if a response is still permitted. Assuming the “Paul James” is the first recipient to respond, “Paul James” may be permitted to generate 120 a response as: a) “Paul James” is the first responder (i.e., meeting the requirements of field 168); b) the deadline has not passed (i.e., meeting the requirements of field 170); and c) “Paul James” is a “TO” recipient (i.e., meeting the requirements of field 172).

Accordingly, collaboration process 10 may allow recipient “Paul James” to generate 120 and transmit 124 response message 212. As discussed above, at least a portion of response 212 may be posted 118 to online collaborative workspace 200. For illustrative purposes, response 212 is shown to include a poster identifier 214 for identifying the poster (e.g., “Paul James”) of the entry within online collaborative workspace 200. Additionally, collaboration process 10 may include time/date stamp 216 that defines the time that the entry was posted to online collaborative workspace 200. When posting 118 response 212 within online collaborative workplace 200, collaboration process 10 may also include message content 218 that was included within the original response (e.g., the original response email message).

As user 46 defined rules that allow two individuals to respond to email message 150, the response message solicited by user 46 (in this particular example) is a multi-part response message that requires a plurality of individual response messages (i.e., namely two responses) to be generated prior to a user being prohibited 126 from generating 120 a response.

Continuing with the above-stated example, assume that “TO” recipient “John Smith” would like to attend the Chicago tradeshow and begins preparing response 220 (in the form of a separate email message) shortly after “Paul James” responds. Again, collaboration process 10 may determine 122 if a response is still permitted. Assuming that “John Smith” is the second recipient to respond, “John Smith” may be permitted to generate 120 a response as: a) “John Smith” is the second responder (i.e., meeting the requirements of field 168); b) the deadline has not passed (i.e., meeting the requirements of field 170); and c) “John Smith” is a “TO” recipient (i.e., meeting the requirements of field 172).

Accordingly, collaboration process 10 may allow recipient “John Smith” to generate 120 and transmit 124 response message 220. As discussed above, at least a portion of response 220 may be posted 118 to online collaborative workspace 200. For illustrative purposes, response 220 is shown to include a poster identifier, and a time/date stamp 216.

Continuing with the above-stated example, assume that “TO” recipient “Mary Jones” would like to attend the Chicago tradeshow also and begins preparing a response (not shown) shortly after “John Smith” responds. Again, collaboration process 10 may determine 122 if a response is still permitted. Assuming that “Mary Jones” is the third recipient to respond, “Mary Jones” may be prohibited 126 from responding as: a) “Mary Jones” is the third responder (i.e., failing to meet the requirements of field 168.

When posting 108, 118 entries within online collaborative workspace, collaboration process 10 may be posted in a chronological fashion. For example, collaboration process 10 may post response 212 (i.e., the response of “Paul James”) subsequent to email message 150 (i.e., the original email from user 46). Additionally, collaboration process 10 may post subsequent response 220 (i.e., the response of “John Smith”) subsequent to response 212 (i.e., the response of “Paul James”).

As discussed above, collaboration process 10 may allow user 46 to assign 110 rights based upon recipient type. For example, collaboration process 10 may grant 112 editorial rights, concerning online collaborative workspace 200, to “TO” recipients 152. Additionally, collaboration process 10 may grant 114 read-only rights, concerning online collaborative workspace 200, to the “CC” recipients 154. Further, collaboration process 10 may grant 116 read-only rights, concerning online collaborative workspace 200, to the “BCC” recipients 156.

In the event that a user's “type” changes, collaboration process 10 may revise 128 the rights of an individual user with respect to online collaborative workspace 200. For example, while “Paul Barclay” is a “CC” recipient with respect to email message, assume that upon “Mary Jones” receiving email message 150, “Mary Jones” transmits an email message (not shown) to “Paul Barclay” (i.e., listing “Paul Barclay” as a “TO” recipient. Accordingly, while “Paul Barclay” was initially (i.e., with respect to email message 150) a “CC” recipient, “Paul Barclay” was only granted 114 read-only rights with respect to online collaboration workspace 200. However, as “Paul Barclay is now a “TO” recipient (i.e., with respect to the email from “Mary Jones”), collaboration process 10 may revise 128 the rights of “Paul Barclay” and grant 112 “Paul Barclay” editorial rights with respect to online collaborative workspace 200.

The manner in which a recipient (e.g., “TO” recipients 152, “CC” recipients 154, and “BCC” recipients 156) may generate responses concerning email message 150 may be based upon one or more rules followed by collaboration process 10. For example, in one implementation of this disclosure, “CC” recipients 154 and “BCC”recipients 156 may be permitted to post a response concerning email message 150 to online collaborative workspace 200. However, “CC” recipients 154 and “BCC” recipients 156 may not be permitted to modify content included within online collaborative workspace 200. In another implementation of this disclosure, “CC” recipients 154 and “BCC” recipients 156 may be permitted to email a response concerning email message 150. However, the response generated by “CC” recipients 154 and “BCC” recipients 156 may not be posted to online collaborative workspace 200. Additionally/alternatively, the manner in which “CC” recipients 154 and “BCC” recipients 156 are permitted to respond concerning email message 150 may be subject to separate sets of rules.

Further, the one or more rules (followed by collaboration process 10) that define the manner in which a recipient (e.g., “TO” recipients 152, “CC” recipients 154, and “BCC” recipients 156) may generate responses concerning email message 150 may be trumped by the rules governing whether a recipient is permitted to respond to e.g., email message 150. As discussed above, collaboration process 10 may allow a first user (e.g., user 46) to generate 100 an email message (e.g., email message 150) that solicits a response. When a second user (e.g., user 48) attempts to generate 120 a response to email message 150 generated 100 by user 46, collaboration process 10 may determine 122 whether a response is still permitted. If 122 the response is still permitted, the second user may be allowed to generate 120 and transmit 124 the response. Accordingly, if a response to email message 150 is no longer permitted, the recipients (e.g., “TO” recipients 152, “CC” recipients 154, and “BCC” recipients 156) may be prohibited from responding to email message 150, regardless of the rules defining the manner in which they may respond to email message 150.

While collaboration process 10 and email server application 20 are shown as being executed on a common computer (i.e., server computer 12), this is for illustrative purposes only and is not intended to be a limitation of this disclosure. Specifically, collaboration process 10 and email server application 20 may each be executed on a separate server computer. Alternatively, either or both of collaboration process 10 and email server application 20 may be executed on a plurality of server computers (not shown).

A number of implementations have been described. Nevertheless, it will be understood that various modifications may be made. Accordingly, other implementations are within the scope of the following claims.

What is claimed is:

1. A method comprising:
generating an email message from a first user that solicits a response message;
determining if the response message to the email message is still permitted; and
if the response message to the email message is still permitted, allowing the generation of the response message by a second user.

2. The method of claim 1 further comprising:
transmitting the email message; and
transmitting the response message.

3. The method of claim 2 further comprising:
posting at least a portion of the email message to an online collaborative workspace.

4. The method of claim 2 further comprising:
posting at least a portion of the response message to the online collaborative workspace.

5. The method of claim 4 wherein the online collaborative workspace is chosen from the group consisting of: a wiki; a blog; a teamspace; a discussion group; and an activity group.

6. The method of claim 4 wherein the at least a portion of the email message and the at least a portion of the response message are posted within the collaborative workspace in a chronological fashion.

7. The method of claim 1 further comprising:
if the response message to the email message is no longer permitted, prohibiting the generation of the response message by the second user.

8. The method of claim 1 wherein the response message solicited is a multi-part response message that includes a plurality of individual response messages, wherein determining if the response message to the email message is still permitted includes:
determining if any of the plurality of individual response messages to the email message are still permitted.

9. The method of claim 8 wherein allowing the generation of the response message by a second user includes:
if any of the plurality of individual response messages to the email message are still permitted, allowing the generation of the response message by the second user.

10. The method of claim 8 further comprising:
if none of the plurality of individual response messages to the email message are still permitted, prohibiting the generation of the response message by the second user.

11. A computer program product residing on a computer readable medium having a plurality of instructions stored thereon which, when executed by a processor, cause the processor to perform operations comprising:
generating an email message from a first user that solicits a response message;
determining if the response message to the email message is still permitted; and
if the response message to the email message is still permitted, allowing the generation of the response message by a second user.

12. The computer program product of claim 11 further comprising instructions for:
transmitting the email message; and
transmitting the response message.

13. The computer program product of claim 12 further comprising instructions for:
posting at least a portion of the email message to an online collaborative workspace.

14. The computer program product of claim 12 further comprising instructions for:
posting at least a portion of the response message to the online collaborative workspace.

15. The computer program product of claim 14 wherein the online collaborative workspace is chosen from the group consisting of: a wiki; a blog; a teamspace; a discussion group; and an activity group.

16. The computer program product of claim 14 wherein the at least a portion of the email message and the at least a portion of the response message are posted within the collaborative workspace in a chronological fashion.

17. The computer program product of claim 11 further comprising instructions for:
if the response message to the email message is no longer permitted, prohibiting the generation of the response message by the second user.

18. The computer program product of claim 11 wherein the response message solicited is a multi-part response message that includes a plurality of individual response messages, wherein the instructions for determining if the response message to the email message is still permitted include instructions for:
determining if any of the plurality of individual response messages to the email message are still permitted.

19. The computer program product of claim 18 wherein the instructions for allowing the generation of the response message by a second user include instructions for:
if any of the plurality of individual response messages to the email message are still permitted, allowing the generation of the response message by the second user.

20. The computer program product of claim 18 further comprising instructions for:
if none of the plurality of individual response messages to the email message are still permitted, prohibiting the generation of the response message by the second user.
